(19) United States
(12) Patent Application Publication
(10) Pub. No.: US 2017/0324574 A1
(43) Pub. Date: Nov. 9, 2017

(54) Method of Enhanced Application Specific Congestion Control for Data Communication Mechanism

(71) Applicant: MEDIATEK INC., Hsinchu (TW)

(72) Inventors: Chien-Chun Huang-Fu, Hsinchu City (TW); Yu-Tien Yeh, New Taipei City (TW); Cheng-Hsiao Ko, Hsinchu City (TW)

(21) Appl. No.: 15/584,379

(22) Filed: May 2, 2017

Related U.S. Application Data
(60) Provisional application No. 62/330,888, filed on May 3, 2016.

(51) Int. Cl. H04L 12/18; H04W 28/02; H04L 29/12; H04L 12/801

(52) U.S. Cl. CPC H04L 12/1877; H04L 47/12; H04W 28/0284; H04W 28/0273; H04L 29/12; H04W 28/0289; H04L 47/33; H04W 28/02

(57) ABSTRACT

AT commands are used for controlling Mobile Termination (MT) functions and GSM/UMTS network services from a Terminal Equipment (TE) through Terminal Adaptor (TA). Application specific access control is an application/service specific access control mechanism for the operator to allow/prevent new access attempts from particular, operator-identified applications/services in the UE in idle mode. However, a TE does not always know the applicability of application specific access control. In accordance with one novel aspect, a new AT command interface that can report application specific access control status to the TE is proposed. It reduces wasteful signaling overhead by retries from the TE. Through the new AT command interface, the TE can query application specific access control status. Via unsolicited result code (URC), the MT can detect application specific access control applicability status change and report updated status to the TE.

### CROSS REFERENCE TO RELATED APPLICATIONS

This application claims priority under 35 U.S.C. §119 from U.S. Provisional Application No. 62/330,888, entitled “Method of Enhanced ACDC Mechanism,” filed on May 3, 2016, the subject matter of which is incorporated herein by reference.

### TECHNICAL FIELD

The disclosed embodiments relate generally to wireless communication, and, more particularly, to method of enhanced application specific access control mechanism using enhanced AT commands.

### BACKGROUND

The wireless cellular communications network has grown exponentially over the years. A Long-Term Evolution (LTE) system offers high peak data rates, low latency, improved system capacity, and low operating cost resulting from simplified network architecture. In LTE networks, an evolved universal terrestrial radio access network (E-UTRAN) includes a plurality of base stations, e.g., evolved Node-Bs (eNBs) communicating with a plurality of mobile stations referred a s user equipments (UEs). With the optimization of the network design, many improvements have developed over various standards, especially in providing wireless IP application services via an Evolved Packet System (EPS) core network (CN).

The EPS/IP bearer and connection management and allocation functionality can be provided towards the applications and the terminal devices using an Application Programming interface (API). For external applications, the EPS/IP bearer and connection management and allocation functionality may be provided through an AT command API in accordance with 3GPP TS 27.007 “AT command set for User Equipment (UE)”. AT commands are used for controlling Mobile Termination (MT) functions and GSM/UMTS network services from a Terminal Equipment (TE) through Terminal Adaptor (TA).

There are services, such as disaster message board service or the disaster voice messaging service, that are used to confirm the safety status of families, relatives, or community members in situations of disaster. Those services have been already used in several occasions and recognized as essential to support general public. Highly congested situation may be caused by natural disaster or public events or triggered by any of a number of reasons. In order to free up network resources based on operator-defined situation, e.g., in radio access network or in core network (RAN/CN) that is congested or about to be congested, it would be useful to have a mechanism (subject to regional regulations) that is able to allow/prohibit communication initiation or operator-defined particular applications in the UE.

Application specific access control is an access control mechanism for the operator to allow/prevent new access attempts from particular, operator-identified applications in the UE in idle mode. Application-Specific Congestion Control for Data Communication (ACDC) is one example of such application specific access control mechanism. Under ACDC mechanism, the network can prevent or mitigate overload of the access network and/or the core network. The configuration of ACDC is mainly defined in the parameters within the system information. However, the presence of these parameters is optional and the current ACDC configuration does not define whether ACDC is applicable. The upper layer entities of the application in the UE often are not aware of whether ACDC is inapplicable. As a result, the ACDC requests from the upper layer entities in the UE will increase unnecessary signaling overhead.

A solution is sought for querying and reporting application specific access control applicability using AT commands between TE and MT.

### SUMMARY

AT commands are used for controlling Mobile Termination (MT) functions and GSM/UMTS network services from a Terminal Equipment (TE) through Terminal Adaptor (TA). Application specific access control is an application or service specific access control mechanism for the operator to allow/prevent new access attempts from particular, operator-identified applications or services in the UE in idle mode. However, a TE does not always know the applicability of application specific access control. In accordance with one novel aspect, a new AT command interface that can report application specific access control status to the TE is proposed. It reduces wasteful signaling overhead by retries from the TE. Through the new AT command interface, the TE can query application specific access control status. Via unsolicited result code (URC), the MT can detect application specific access control applicability status change and report updated status to the TE. Application-Specific Congestion Control for Data Communication (ACDC) is one example of such application specific access control mechanism.

In one embodiment, a terminal equipment (TE) transmits a first Attention (AT) read command in a mobile communication network. The first AT command is for querying application specific access control status information. The TE receives a response from a mobile termination (MT). The response includes the application specific access control status information indicating whether application specific access control is applicable. The TE attempts to establish a connection with the network by sending a second AT command to the MT for providing application information when application specific access control is applicable, otherwise the TE is refrain from sending the second AT command when application specific access control is inapplicable.

In another embodiment, a mobile terminal (MT) determines application specific access control status information in a mobile communication network. The MT detects whether the application specific access control status information has changed. The application specific access control status information comprises whether application specific access control is applicable. The MT determines whether the application specific access control status reporting is enabled by a terminal equipment (TE). The MT transmits updated application specific access control status information to the TE via an Unsolicited Result Code (URC) if the application specific access control status information has changed and if application specific access control status reporting is enabled.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 3GPP wireless network and a user equipment (UE) with Application-Specific Congestion Control for Data Communication (ACDC) mechanism in accordance with one novel aspect.

FIG. 2 illustrates a simplified block diagram of an architecture comprising a Terminal Equipment (TE) and a Mobile Termination (MT) interfaced by a Terminal Adaptor (TA) in accordance with one novel aspect.

FIG. 3 illustrates a simplified block diagram of a Terminal Equipment (TE) in accordance with embodiments of the current invention.

FIG. 4 illustrates a simplified block diagram of a Mobile Termination (MT) in accordance with embodiments of the current invention.

FIG. 5 illustrates one embodiment of an AT command +CACDCS for acquiring ACDC status information and enabling or disabling ACDC status reporting in accordance with one novel aspect.

FIG. 6 illustrates a message flow between a TE and an MT for querying ACDC status by the TE.

FIG. 7 illustrates a mechanism of reporting ACDC status information by an MT using Unsolicited Request Code (URC) upon detecting ACDC status change.

FIG. 8 illustrates a message flow between a TE and an MT for reporting ACDC status information by the MT.

FIG. 9 illustrates a first embodiment of reporting ACDC status information when the network does not configure ACDC parameters in SIB2.

FIG. 10 illustrates a second embodiment of reporting ACDC status information when ACDC is only applicable in home network.

FIG. 11 illustrates a third embodiment of reporting ACDC status information upon failure of RRC connection setup procedure.

FIG. 12 is a flow chart of a method of controlling application specific access control status reporting from MT perspective in accordance with one novel aspect.

FIG. 13 is a flow chart of a method of controlling application specific access control status reporting from TE perspective in accordance with one novel aspect.

### DETAILED DESCRIPTION

Reference will now be made in detail to some embodiments of the invention, examples of which are illustrated in the accompanying drawings.

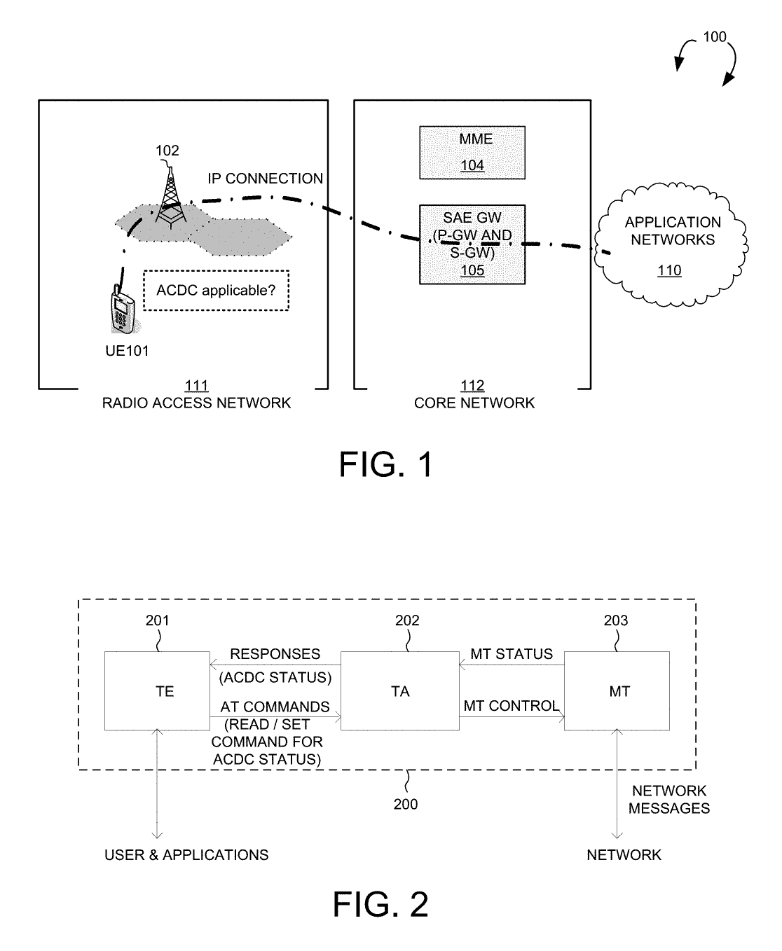

FIG. 1 illustrates an exemplary 3GPP wireless network 100 and a user equipment (UE) 101 with Application-Specific Congestion Control for Data Communication (ACDC) mechanism in accordance with one novel aspect. 3GPP system 100 is a Public Land Mobile Network (PLMN) or an Equivalent Public Land Mobile Network (EPLMN) that supports one or more wireless radio access technology (RAT) networks such as a 4G/LTE system. Each of the 3GPP system has a fixed base infrastructure unit, such as wireless communications station 102, forming wireless networks distributed over a geographical region. The base unit may also be referred to as an access point, an access terminal, a base station, a NodeB, an eNodeB, or by other terminology used in the art. Each of the wireless communications station serves a geographic area. In the example of FIG. 1, a 4G/LTE system has an evolved node-B (eNodeB) 102 connecting with a system architecture evolution (SAE) gateway 105, which includes the serving gateway (S-GW) and the packet data network (PDN) gateway (P-GW).

A wireless communications device/user equipment (UE) 101 in 3GPP system 100 can be served by eNodeB 102 of the radio access network (RAN) 111 to access application networks 110 through core network CN 112. CN 112 comprises a mobility management entity (MME) 104 and SAE-GW 105. In radio resource control (RRC) idle mode, UE 101 may camp on eNB 102 and receive broadcasting information. In RRC connected mode, UE 101 establishes a RRC connection with eNB 102 and a data radio bearer (DRB) with 3GPP system 100 for dedicated data services. Application specific access control is an access control mechanism for the operator to allow/prevent new access attempts from particular, operator-identified applications in the UE in idle mode. Application-Specific Congestion Control for Data Communication (ACDC) is one example of such application specific access control mechanism.

For external applications, the EPS/IP bearer and connection management and allocation functionality may be provided through an AT command API in accordance with 3GPP TS 27.007 “AT command set for User Equipment (UE)”. AT commands are used for controlling Mobile Termination (MT) functions and GSM/UMTS network services from a Terminal Equipment (TE) through Terminal Adaptor (TA). In the example of FIG. 1, UE 101 comprises a TE, a TA, and an MT. TE can use AT commands to control MT to perform ACDC mechanism. However, a TE does not always know the applicability of ACDC. In accordance with one novel aspect, a new AT command interface that can report ACDC status to the TE is proposed. It reduces wasteful retries from the TE. Through the new AT command interface, the TE can query ACDC status. Via unsolicited result code (URC), the MT can detect ACDC applicability status change and report updated ACDC status to the TE.

FIG. 2 illustrates a simplified block diagram of an architecture of a user equipment UE 200 comprising a Terminal Equipment (TE 201) and a Mobile Termination (MT 203) interfaced by a Terminal Adaptor (TA 202) in accordance with one novel aspect. 3GPP IS 27.007 defines plurality of AT commands for controlling MT functions and GPRS packet domain services based on PDP contexts. The TA, MT and TE may be implemented in the form of separate or integrated entities as needed. The span of control of the defined AT commands allows handling of any physical implementation that may lead to: TA, MT and TE as three separate entities; TA integrated under the MT cover, and TE Implemented as a separate entity; TA integrated under the TE cover, and MT implemented as a separate entity; and TA and MT integrated under the TE cover as a single entity.

In the example of FIG. 2, the AT commands are observed on the link between E 201 and TA 202. However, most of the AT commands exchange information about the MT, not about the TA. The Interface between TE 201 and TA 202 operates over existing serial cables, infrared link, and all link types with similar behavior. The interface between TA 202 and MT 203 is dependent on the interference within MT 203. In one embodiment, TE 201 sends an AT command to TA 202, which converts to an MT control to be sent to MT 203. The AT commands can be a read command for retrieving ACDC status from MT 203, or a set command for enabling or disabling automatic ACDC status reporting for MT 203. In response, MT 203 sends ACDC status back to TA 202, which converts to a response to be sent to TE 201. The response can include the updated ACDC applicability information.

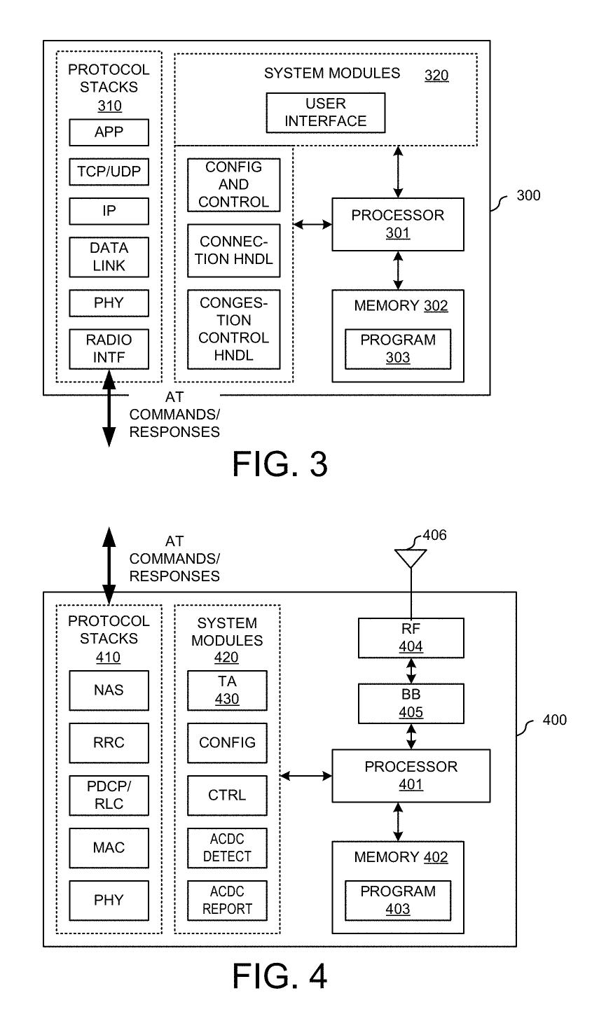

FIG. 3 illustrates a simplified block diagram of a Terminal Equipment (TE 300) in accordance with embodiments of the current invention. TE 300 comprises a processor 301, memory 302, and protocol stacks 310 including Application (APP) layer, Transport (TCP/UDP) layer, Network (IP) layer, Data Link layer, and Physical (PHY) layer. TE 300 further comprises system control modules 320 including a user interface, a configuration and control module, a connection handler, and a congestion control handler. Processor 301 processes different applications and invokes different system control modules to perform various features of TE 300. Memory 302 stores program instructions and data 303 to control the operations of TE 300. The system control modules and circuits can be implemented and configured to carry out functional tasks of TE 300. In one example, TE 300 sends an AT read command to retrieve ACDC status from the modem. In another example, TE 300 sends an AT set command to enable or disable ACDC status reporting option. The TE 300 thus can determine whether ACDC is applicable before sending subsequent ACDC related requests and parameters.

FIG. 4 illustrates a simplified block diagram of a Mobile Termination (MT 400) in accordance with embodiments of the current invention. MT 400 has an antenna 406, which transmits and receives radio signals. A RF transceiver module 404, coupled with the antenna, receives RF signals from antenna 406, converts them to baseband signals and sends them to processor 401 via baseband module 405. RF transceiver 404 also converts received baseband signals from processor 401 via baseband module 405, converts them to RF signals, and sends out to antenna 406. Processor 401 processes the received baseband signals and invokes different functional modules to perform features in MT 400. Memory 402 stores program instructions and data 403 to control the operations of MT 400.

MT 400 also comprises a set of protocol stacks 410 and control circuits including various system modules 420 to carry out functional tasks of MT 400. Protocol stacks 410 comprises Non-Access-Stratum (NAS) layer, Radio Resource Control (RRC) layer, Packet Data Convergence Protocol/Radio Link Control (PDCP/RLC) layer, Media Access Control (MAC) layer, and Physical (PHY) layer. System modules 420 comprises a configuration module, a control module, a ACDC status detector for detecting any event that triggers the change of ACDC status, and ACDC status reporting module for reporting ACDC status information. In the example of FIG. 4, MT 400 further comprises a Terminal Adaptor (TA 430) that receives and transmits AT commands and converts the AT commands to be processed by processor 401 for controlling MT functions. In one example, TA 430 receives an AT read command from a TE for the MT to retrieve ACDC status. In another example, TA 430 receives an AT set command from a TE for setting ACDC status reporting option such that the MT can detect ACDC status change and report the updated ACDC applicability status information accordingly.

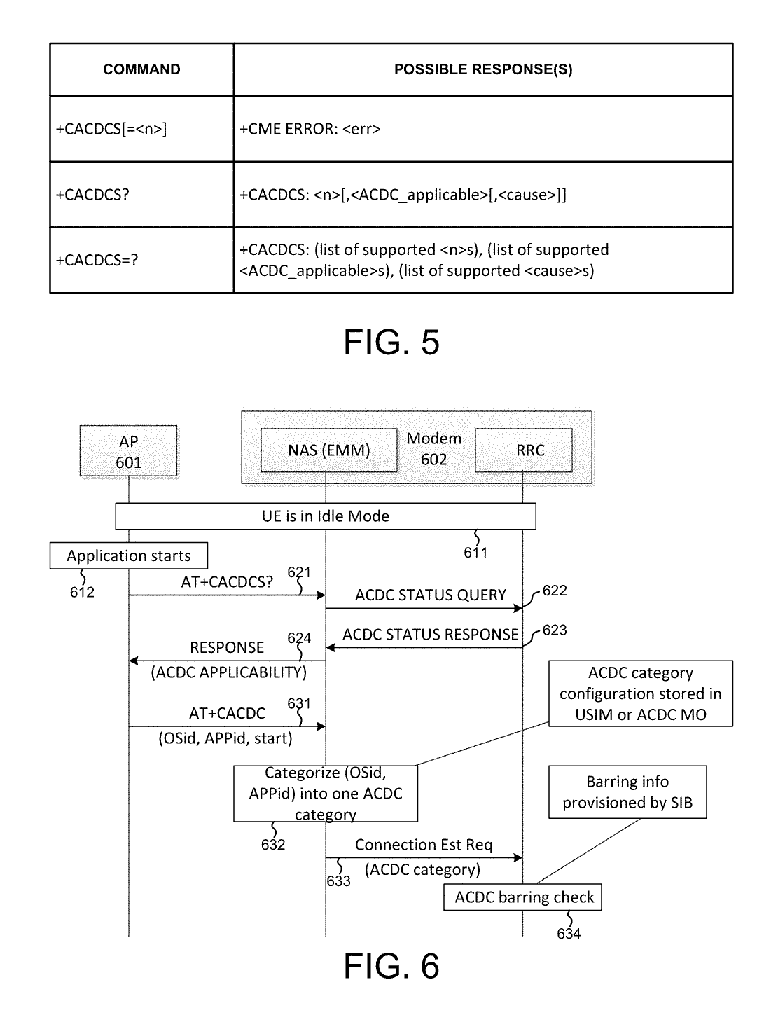

FIG. 5 illustrates one embodiment of an AT command +CACDCS for acquiring ACDC status information and enabling or disabling ACDC status reporting in accordance with one novel aspect. As illustrated in FIG. 5, the AT+CACDS command is a set or read or test command. The execution of the set command enables or disables the WLAN ACDC status reporting. If reporting is enabled by <n>=1, the MT returns the following unsolicited result code from MT to TE whenever the ACDC applicability status changes at the MT: +CACDCSI: [,<ACDC_applicable>[,<cause>]]. If a setting is not supported by the MT, +CME ERROR:<err> is returned. The execution of the read command returns the current status of <n> and the ACDC status data currently available at the MT. The execution of the test command returns the values supported by MT as compound values. The ACDC status data may include ACDC applicability, ACDC parameters including acdc-HPLMNonly, ACDC barring status, and ACDC barring factors, etc.

The defined values of the relevant information include: <n>: integer type, <n>=0 disables ACDC status data unsolicited result code, <n>=1 enables ACDC status data unsolicited result code; <ACDC_applicable>: integer type, indicates the current applicability of ACDC functionality, a value of 0 indicates ACDC is inapplicable, a value of 1 indicates ACDC is applicable; <cause>: integer type, indicates the reason why ACDC is inapplicable [optional], a value of 0 indicates network provides no valid ACDC configuration, a value of 1 indicates ACDC is inapplicable in roaming case, a value of 2 indicates ACDC is inapplicable due to RRC connection reject message (e.g., T302 is running).

FIG. 6 illustrates a message flow between a TE and an MT for querying ACDC status by the TE. TE 601 is also referred to as an Application Processor (AP), while MT 602 is also referred to as a Modulator/Demodulator (modem). Modem 602 further comprises a NAS layer entity for enhanced mobility management (EMM) and an RRC layer entity for radio resource control (RRC). AP 601 and modem 602 may be located within the same UE. In step 611, the UE is in RRC idle mode. In step 612, AP 601 starts an application service and needs to establish an RRC connection with the network, which may involve the ACDC congestion control mechanism. However, AP 601 may not be aware of whether ACDC is inapplicable. Accordingly, in step 621, AP 601 sends an AT command +CACDCS? to MT 602 for acquiring the ACDC status currently available at the MT. The NAS layer entity forwards the AT command to the RRC layer in step 622. In step 623, the RRC layer entity processes the AT command and sends a response back to the NAS layer entity. In step 624, the NAS layer entity forwards the response to AP 601 with the current ACDC applicability status. If ACDC is applicable, in step 631, AP 601 sends another AT command +CACDC to the NAS layer entity. The +CACDC AT command indicates an ACDC request with parameters including an application ID and an OS ID for starting the application. In step 632, the NAS layer entity categorizes the OS ID and the application ID into one ACDC category. In one example, the ACDC category configuration is stored in USIM (reference TS 31.102 sub-clause 4.4.9). The elementary file (EF) EF_{ACDC}_{_}_{LIST} contains the link to EFs containing the ACDC for each operating system identifier, and EF_{ACDC}_{_}_{OS}_{_}_{CONFIG} contains the ACDC configuration for a specific Operating System. In another example, the ACDC category configuration is stored in ACDC MO (reference TS 24.105). In step 633, the NAS layer entity sends a connection establishment request with the ACDC category to the RRC layer entity. In step 634, the RRC layer entity performs ACDC barring check for the ACDC category. The barring information is provisioned based on system information block (SIB) from the network. The barring information includes the acdc-Category, the Barring Factor (the probability of barring) and the Barring Time (reference TS 36.331 sub-clause 6.3.1).

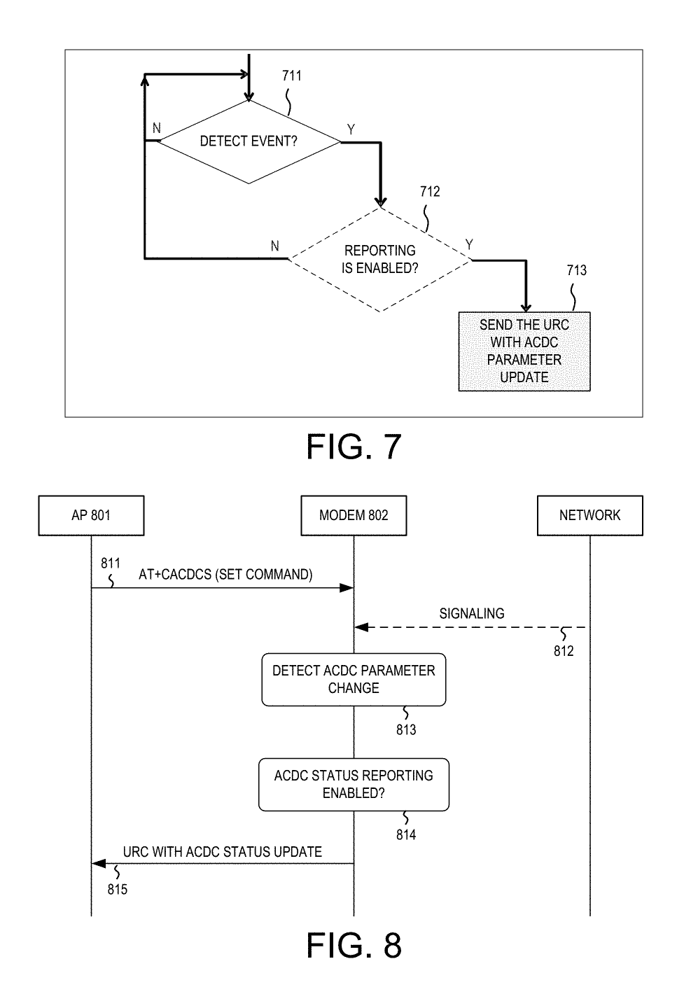

FIG. 7 illustrates a mechanism of reporting ACDC status information by an MT using Unsolicited Request Code (URC) upon detecting ACDC status change. For normal communication between TE and MT, TE will issue AT commands and MT will respond to the AT commands. URC is an exception. URC indicates the occurrence of an event not directly associated with issuance of any AT command from TE. Under URC, MT will actively report predefined events without any AT command from TE. As illustrated in FIG. 7, in step 711, an MT detects whether the ACDC status has changed. In step 712, the MT checks whether ACDC status reporting is enable or disabled. In step 713, if ACDC status reporting is enable, then the MT sends URC with the updated ACDC status to the TE. Note the step 712 is optional and may be omitted.

FIG. 8 illustrates a message flow between a TE and an MT for reporting ACDC status information by the MT. TE 801 is also referred to as an Application Processor (AP), while MT 802 is also referred to as a Modulator/Demodulator (modem). In step 811, the AP sends an AT command enable or disable ACDC status reporting (e.g., via AT+CACDCS set command). In step 812, the modem receives signaling from the network regarding the ACDC status. For example, the modem may receive ACDC parameters such as ACDC barring list or ACDC HPLMN entry from the network. In step 813, the modem detects whether the ACDC applicability has changed from a previous value. For example, the modem stores the previous ACDC applicability in its memory. In step 814, the modem checks whether ACDC status reporting is enable or disabled. In step 815, if the ACDC applicability has changed and if ACDC status reporting is enabled, then the modem sends URC with the newly updated ACDC status to the AP. Note that the modem reports the newly updated ACDC status using URC without receiving any specific AT command from the AP.

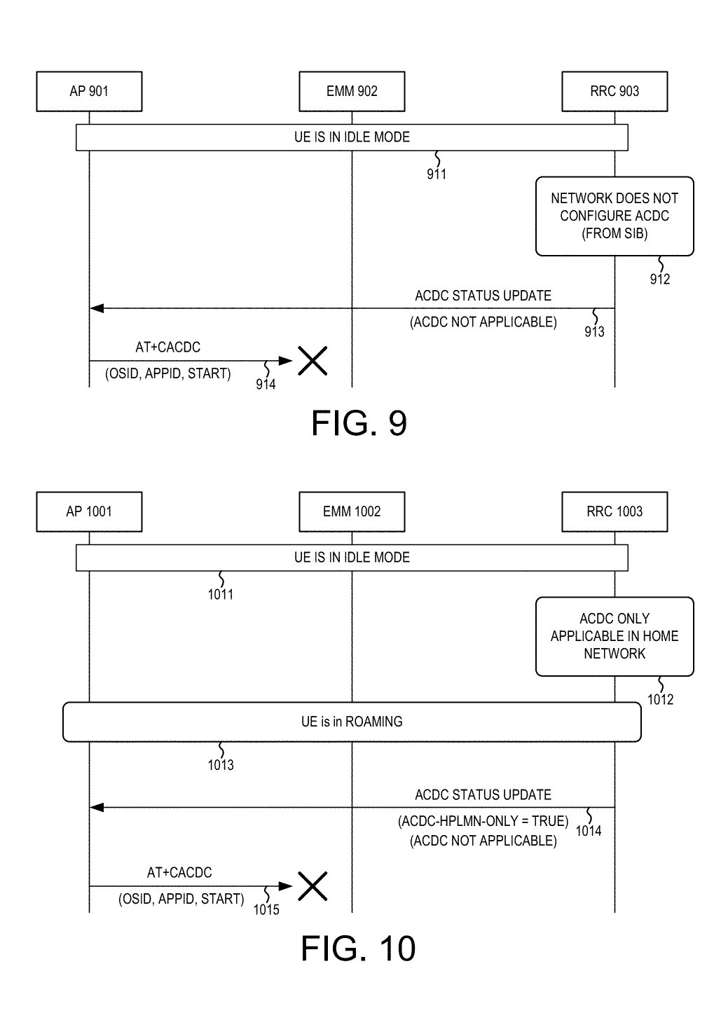

FIG. 9 illustrates a first embodiment of reporting ACDC status information when the network does not configure ACDC parameters in SIB2. In the example of FIG. 9, a UE comprises an Application Processor AP 901, a NAS layer entity 902 for enhanced mobility management (EMM), and an RRC layer entity 903 for radio resource control (RRC). In step 911, the UE is in RRC idle mode. In step 912, RRC 903 determines that the network does not configure all the ACDC parameters properly from SIB2. The configuration of ACDC is mainly defined in the parameters within the SIB (e.g., “acdc-BarringForCommon-r13” and “acdc-BarringPerPLMN-list-r13”). However, the presence of theses parameters is optional and the SIB does not define whether ACDC is applicable in some cases. For example, if only “acdc-BarringPerPLMN-List-r13” is present, but it contains no corresponding entry to the PLMN selected by upper layers, then ACDC is not applicable. Further, if no “acdc-BarringForCommon-r13” and no “acdc-BarringPerPLMN-List-r13” is present, then ACDC is not applicable. If RRC 903 detects that ACDC is inapplicable, then in step 913, RRC 903 sends URC with the ACDC status update to AP 901, indicating that ACDC is inapplicable. As a result, AP 901 is refrained from sending ACDC related request to EMM 902 or RRC 903 to prevent unnecessary signaling overhead.

FIG. 10 illustrates a second embodiment of reporting ACDC status information when ACDC is only applicable in home network. In the example of FIG. 10, a UE comprises an Application Processor AP 1001, a NAS layer entity 1002 for enhanced mobility management (EMM), and an RRC layer entity 1003 for radio resource control (RRC). In step 1011, the UE is in RRC idle mode. In step 1012, RRC 1003 determines that the network has configured ACDC with the configuration that ACDC is only applicable in the home HPLMN (i.e., ACDC-HPLMN=TRUE) in SIB2. In step 1013, UE is in roaming. In such case, when UE is roaming, the RRC layer applies ACB barring check instead of ACDC barring check. ACB barring is based on the corresponding establishment type, e.g., MO-data, MO-signaling, but not base on application type. The roaming related parameter (e.g., ACDC-HPLMN) is within the “acdc-BarringPerPLMN-List” if corresponding PLMN entry is included, or within the “acdc-BarringForCommon” otherwise. If RRC 1003 detects that ACDC is applicable only for HPLMN and the UE is in roaming, then in step 1014, RRC 1003 sends URC to AP 1001. In a first option, RRC 1003 sends URC with the ACDC parameter update, indicating ACDC-HPLMN=TRUE, upon detecting the value of acdc-HPLMNonly is initially received or changed. In a second option, RRC 1003 sends URC on ACDC status update, indicating ACDC is inapplicable. As a result, AP 1001 knows that ACDC is inapplicable, and is refrained from sending ACDC related request to EMM 1002 or RRC 1003 to prevent unnecessary signaling overhead.

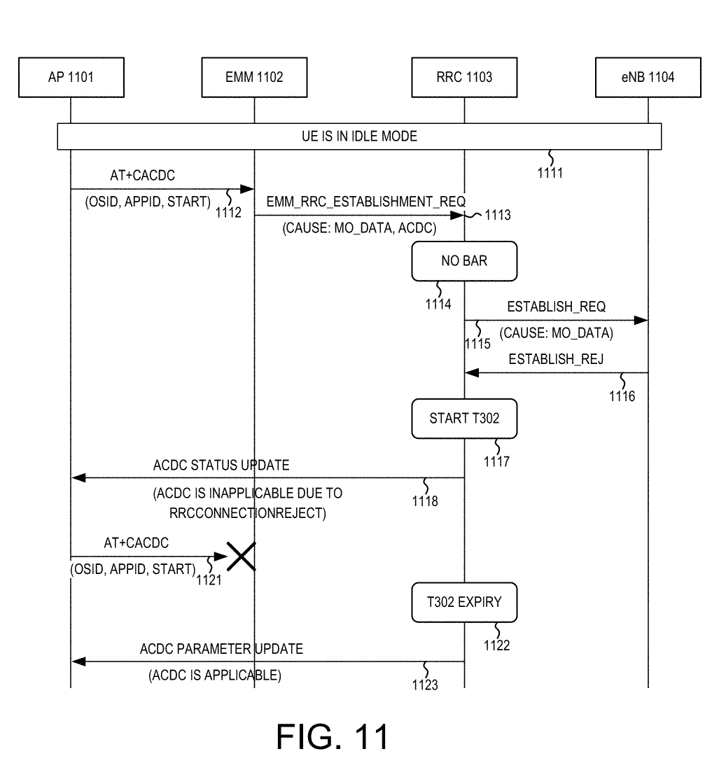

FIG. 11 illustrates a third embodiment of reporting ACDC status information upon failure of RRC connection setup procedure. In the example of FIG. 11, a UE comprises an Application Processor AP 1101, a NAS layer entity 1102 for enhanced mobility management (EMM), and an RRC layer entity 1103 for radio resource control (RRC). In step 1111, the UE is in RRC idle mode and camps on base station eNB 1104. In step 1112, AP 1101 sends an AT command +CACDC to EMM 1102 for establishing an RRC connection. The +CACDC AT command indicates an ACDC request with parameters including an application ID and OS ID for starting the application. In step 1113, EMM 1102 categorizes the OS ID and the application ID into one ACDC category and sends a connection establishment request with the ACDC category to RRC 1103. In step 1114, RRC 1103 performs ACDC barring check for the ACDC category and determines that there is no bar. In step 1115, RRC 1103 sends an establishment request message to eNB 1104. In step 1116, RRC 1103 receives an establishment reject message from eNB 1104. In step 1117, RRC 1103 starts a timer T302. When ACDC is barred, an indication is sent from RRC 1103 to AP 1101 via URC in step 1118 upon ACDC applicability status update. When ACDC is not applicable, the indication may include the ACDC applicability, the cause (e.g., T302 is running), and the ACDC parameters. In step 1121, AP 1101 is refrained from sending subsequent ACDC related requests and parameters to prevent unnecessary signaling overhead. In step 1122, the T302 timer expires. Upon ACDC is applicable, another indication can be sent from RRC 1103 to AP 1101 via URC in step 1123.

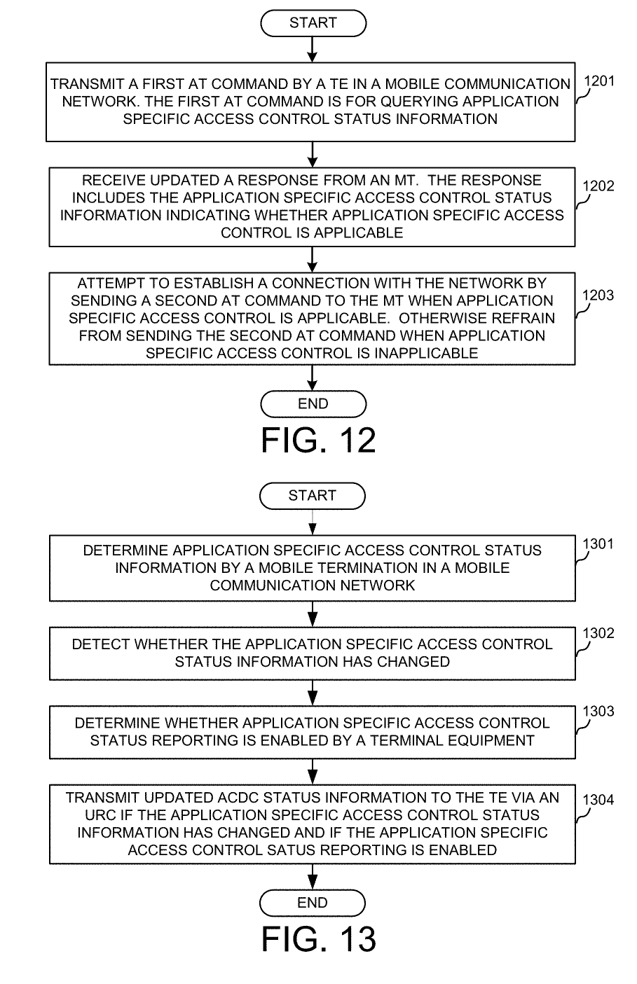

FIG. 12 is a flow chart of a method of controlling application specific access control status reporting from MT perspective in accordance with one novel aspect. In step 1201, a terminal equipment (TE) transmits a first Attention (AT) read command in a mobile communication network. The first AT command is for querying application specific access control status information. In step 1202, the TE receives a response from a mobile termination (MT). The response includes the application specific access control status information indicating whether application specific access control is applicable. In step 1203, the TE attempts to establish a connection with the network by sending a second AT command for providing application information to the MT when application specific access control is applicable, otherwise refrain from sending the second AT command when application specific access control is inapplicable.

FIG. 13 is a flow chart of a method of controlling application specific access control status reporting from TE perspective in accordance with one novel aspect. In step 1301, a mobile terminal (MT) determines application specific access control status information in a mobile communication network. In step 1302, the MT detects whether the application specific access control status information has changed. The application specific access control status information comprises whether application specific access control is applicable. In step 1303, the MT determines whether application specific access control status reporting is enabled by a terminal equipment (TE). In step 1304, the MT transmits updated application specific access control status information to the TE via an Unsolicited Result Code (URC) if the application specific access control status information has changed and if the application specific access control status reporting is enabled.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
transmitting a first Attention (AT) read command by a terminal equipment (TE) in a mobile communication network, wherein the first AT command is for querying application specific access control status information;
receiving a response from a mobile termination (MT), wherein the response includes the application specific access control status information indicating whether application specific access control is applicable; and
attempting to establish a connection with the network by sending a second AT command for providing application information to the MT when application specific access control is applicable, otherwise refrain from sending the second AT command when application specific access control is inapplicable.

2. The method of claim 1, wherein the response also indicates a reason why application specific access control is inapplicable.

3. The method of claim 2, wherein the reason comprises one of the network has not provided valid configuration for application specific access control, application specific access control is inapplicable when in roaming, and application specific access control is inapplicable due to a connection rejection from the network.

4. The method of claim 1, further comprising:
enabling/disabling application specific access control status reporting by sending an AT set command to the MT.

5. The method of claim 4, wherein the TE receives updated application specific access control status information via an Unsolicited Result Code (URC) from the MT if the application specific access control status information has changed and if the application specific access control status reporting is enabled.

6. A terminal equipment (TE), comprising:
a transmitter that transmits a first Attention (AT) read command by a terminal equipment (TE) in a mobile communication network, wherein the first AT command is for querying application specific access control status information;
a receiver that receives a response from a mobile termination (MT), wherein the response includes the application specific access control status information indicating whether application specific access control is applicable; and
a connection handling circuit that attempts to establish a connection with the network by sending a second AT command for providing application information to the MT when application specific access control is applicable, otherwise refrain from sending the second AT command when application specific access control is inapplicable.

7. The TE of claim 6, wherein the response also indicates a reason why application specific access control is inapplicable.

8. The TE of claim 7, wherein the reason comprises one of the network has not provided valid configuration for application specific access control, application specific access control is inapplicable when in roaming, and application specific access control is inapplicable due to a connection rejection from the network.

9. The TE of claim 6, wherein the TE enables or disables application specific access control status reporting by sending an AT set command to the MT.

10. The TE of claim 9, wherein the TE receives updated application specific access control status information via an Unsolicited Result Code (URC) from the MT if the application specific access control status information has changed and if the application specific access control status reporting is enabled.

11. A method, comprising:
determining application specific access control status information by a mobile termination (MT) in a mobile communication network;
detecting whether the application specific access control status information has changed, wherein the application specific access control status information comprises whether application specific access control is applicable;
determining whether application specific access control status reporting is enabled by a terminal equipment (TE); and
transmitting updated application specific access control status information to the TE via an Unsolicited Result Code (URC) if the application specific access control status information has changed and if the application specific access control status reporting is enabled.

12. The method of claim 11, wherein the application specific access control status information further comprises a reason why application specific access control is inapplicable.

13. The method of claim 11, wherein the reason comprises one of the network has not provided valid configuration for application specific access control, application specific access control is inapplicable when in roaming, and application specific access control is inapplicable due to a connection rejection from the network.

14. The method of claim 11, wherein the application specific access control status reporting is enabled or disabled via an Attention (AT) set command sent from the TE.

15. The method of claim 11, wherein the MT reports the application specific access control status information in response to an Attention (AT) read command sent from the TE.

16. A Mobile Termination (MT) comprising:
a detector that determines application specific access control status information in a mobile communication network, wherein the MT also detects whether the application specific access control status information has changed, wherein the application specific access control status information comprises whether application specific access control is applicable;
a status reporting circuit that determines whether application specific access control status reporting is enabled by a terminal equipment (TE); and
a transmitter that transmits updated application specific access control status information to the TE via an Unsolicited Result Code (URC) if the application specific access control status information has changed and if the application specific access control status reporting is enabled.

17. The MT of claim 16, wherein the application specific access control status information further comprises a reason why application specific access control is inapplicable.

18. The MT of claim 16, wherein the reason comprises one of the network has not provided valid configuration for application specific access control, application specific access control is inapplicable when in roaming, and application specific access control is inapplicable due to a connection rejection from the network.

19. The MT of claim 16, wherein the application specific access control status reporting is enabled or disabled via an Attention (AT) set command sent from the TE.

20. The MT of claim 16, wherein the MT reports the application specific access control status information in response to an Attention (AT) read command sent from the TE.
